(19) United States
(12) Patent Application Publication
(10) Pub. No.: US 2023/0409779 A1
(43) Pub. Date: Dec. 21, 2023

(54) SIMULATION APPARATUS AND STORAGE MEDIUM

(71) Applicant: CANON KABUSHIKI KAISHA, Tokyo (JP)

(72) Inventors: KEN KATSUTA, Saitama (JP); YUICHIRO OGUCHI, Tokyo (JP)

(21) Appl. No.: 18/329,669

(22) Filed: Jun. 6, 2023

(30) Foreign Application Priority Data
Jun. 20, 2022 (JP) 2022-099046

(51) Int. Cl. G06F 30/20

(52) U.S. Cl. CPC G06F 30/20

(57) ABSTRACT

A simulation apparatus that predicts a behavior of a curable composition in a film forming process includes a processor configured to execute behavior computation of the curable composition by a computational method selected from a first computational method and a second computational method which shortens a computation time as compared to the first computational method. The processor is configured to execute behavior computation of the curable composition by the second computational method while applying each of a plurality of tentative parameter sets for the film forming process, decide, from the plurality of tentative parameter sets, a parameter set that produces a result of the behavior computation satisfying a predetermined criterion for evaluation, and execute behavior computation of the curable composition by the first computational method while applying the decided parameter set.

### BACKGROUND OF THE INVENTION

### Field of the Invention

The present invention relates to a simulation apparatus and a storage medium.

### Description of the Related Art

There is a film forming technique of forming a film made of a curable composition on a substrate by arranging the curable composition on the substrate, bringing the curable composition into contact with a mold, and curing the curable composition. Such film forming technique is applied to an imprint technique and a planarization technique. In the imprint technique, by using a mold having a pattern region, the pattern of the mold is transferred to a curable composition on a substrate by bringing the curable composition on the substrate into contact with the pattern region of the mold and curing the curable composition. In the planarization technique, by using a mold having a flat surface, a film having a flat upper surface is formed by bringing a curable composition on a substrate into contact with the flat surface and curing the curable composition.

The curable composition is arranged in the form of droplets on the substrate, and the mold is then pressed against the droplets of the curable composition. This spreads the droplets of the curable composition on the substrate, thereby forming a film of the curable composition. At this time, it is important to form a film of the curable composition with a uniform thickness and not to leave bubbles in the film. To achieve this, the arrangement of the droplets of the curable composition, a method and a condition for pressing the mold against the curable composition, and the like are adjusted. To implement this adjustment operation by trial and error using an apparatus, enormous time and cost are required. To cope with this, the use of a simulator that supports such adjustment operation is desired.

Japanese Patent Laid-Open No. 2020-123719 describes a simulation method advantageous in computing, in a shorter time, the behavior of a curable composition in a process of forming a film of the curable composition. A computational grid formed by a plurality of computational components are defined such that multiple droplets of the curable composition fall within one computational component, and the behavior of the curable composition in each computational component is obtained in accordance with a model corresponding to the state of the curable composition in each computational element. Thus, the higher computational speed is implemented.

Since the computational speed has been increased as described above, simulation can be actively used for adjustment, and the labor of trial and error by the actual machine is reduced.

In a film forming apparatus such as an imprint apparatus, there is a step of deciding, as a drop recipe, the amount and arrangement of the droplets of a curable composition to be supplied onto a substrate before a mass production step. In order to check the quality of the drop recipe, an operation of actually performing an imprint process and checking unfilling and extrusion of the curable composition is performed. In order to decide the drop recipe, this check operation is normally performed a plurality of times while changing the parameters of the drop recipe.

In order to reduce the number of the check operations, a method of deciding the drop recipe using simulation is used. Since the quality of the drop recipe can be predicted by computation without actually performing the imprint process, the number of the imprint processes can be reduced, and the time required to decide a parameter set, which is a set of imprint conditions, can be shortened.

In the procedure of deciding the drop recipe by filling simulation, loop processing including referring to the computation result, creating the next computation condition, and executing computation again is performed a plurality of times. Therefore, if the search range for the arrangement and amount is widened, the number of computations increases, and this leads to a problem that decision takes time.

In the conventional filling simulation, coupled analysis of the composition flow and the mold deformation concerning the fluid structure is mainly performed. In this analysis, in order to increase computation accuracy, computation is executed in consideration of a plurality of physical phenomena. Coupled computation considering a plurality of physical phenomena tends to require a long computation time per one computation. Since it is not always necessary to execute high-accuracy computation in all computations for determining the quality of the arrangement and amount of drops, it is demanded to shorten the computation time per one computation by a simple computational method.

### SUMMARY OF THE INVENTION

The present invention provides a simulation technique advantageous in shortening the time required to decide a parameter set for a film forming process.

The present invention in its one aspect provides a simulation apparatus that predicts a behavior of a curable composition in a film forming process in which a plurality of droplets of the curable composition arranged on a substrate and a mold are brought into contact with each other to form a film of the curable composition on the substrate, the apparatus including a processor configured to execute behavior computation of the curable composition by a computational method selected from a first computational method and a second computational method which shortens a computation time as compared to the first computational method, wherein the processor is configured to execute behavior computation of the curable composition by the second computational method while applying each of a plurality of tentative parameter sets for the film forming process, decide, from the plurality of tentative parameter sets, a parameter set that produces a result of the behavior computation satisfying a predetermined criterion for evaluation, and execute behavior computation of the curable composition by the first computational method while applying the decided parameter set.

Further features of the present invention will become apparent from the following description of exemplary embodiments (with reference to the attached drawings).

### BRIEF DESCRIPTION OF THE DRAWINGS

FIG. 1 is a view showing the arrangements of a film forming apparatus and an information processing apparatus;

FIGS. 2A and 2B are views for explaining two computational modes included in a simulation program;

FIG. 3 is a flowchart for explaining the computational procedure of simulation in the first embodiment;

FIG. 4 is a view showing an example of a GUI in the second embodiment; and

FIG. 5 is a flowchart for explaining the computational procedure of simulation in the third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

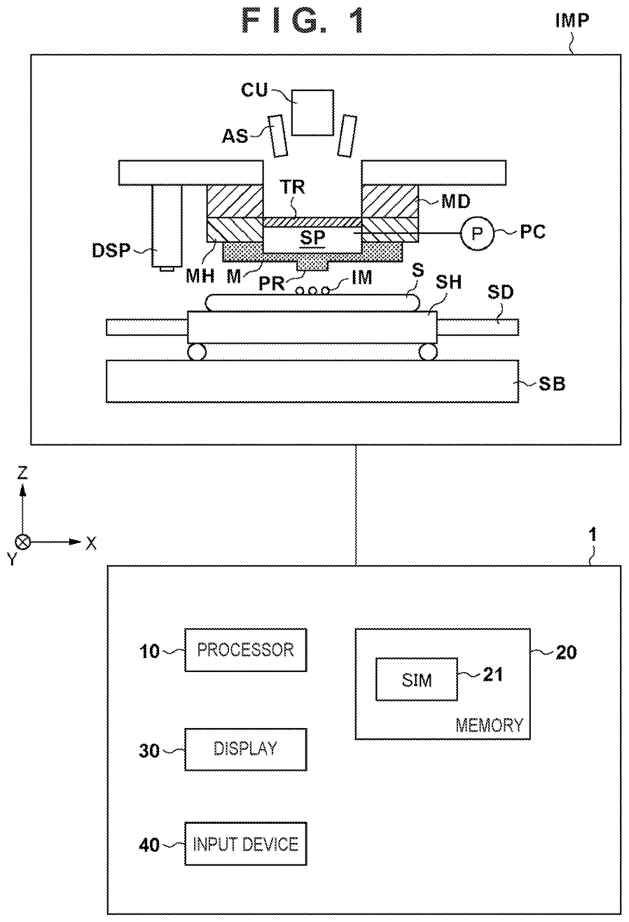

FIG. 1 is a schematic view showing the arrangements of a film forming apparatus IMP and an information processing apparatus 1 according to an embodiment of the present invention. The film forming apparatus IMP executes a film forming process of bringing a plurality of droplets of a curable composition IM arranged on a substrate S into contact with a mold M and forming a film of the curable composition IM in a space between the substrate S and the mold M. The film forming apparatus IMP may be formed as, for example, an imprint apparatus or a planarization apparatus. The substrate S and the mold M are interchangeable, and a film of the curable composition IM may be formed in the space between the mold M and the substrate S by bringing a plurality of droplets of the curable composition IM arranged on the mold M into contact with the substrate S.

The imprint apparatus uses the mold M having a pattern to transfer the pattern of the mold M to the curable composition IM on the substrate S. The imprint apparatus uses the mold M having a pattern region PR provided with a pattern. As an imprint process, the imprint apparatus brings the curable composition IM on the substrate S into contact with the pattern region PR of the mold M, fills, with the curable composition IM, a space between the mold M and a region of the substrate S where the pattern is to be formed, and then cures the curable composition IM. This transfers the pattern of the pattern region PR of the mold M to the curable composition IM on the substrate S. For example, the imprint apparatus forms a pattern made of a cured product of the curable composition IM in each of a plurality of shot regions of the substrate S.

As a planarization process, using the mold M having a flat surface, the planarization apparatus brings the curable composition IM on the substrate S into contact with the flat surface of the mold M, and cures the curable composition IM, thereby forming a film having a flat upper surface. If the mold M having dimensions (size) that cover the entire region of the substrate S is used, the planarization apparatus forms a film made of a cured product of the curable composition IM on the entire region of the substrate S. In order to provide a specific example, a case in which the film forming apparatus IMP is an imprint apparatus will be described in this embodiment.

As the curable composition, a material to be cured by receiving curing energy is used. As the curing energy, an electromagnetic wave or heat can be used. The electromagnetic wave includes, for example, light selected from the wavelength range of 10 nm (inclusive) to 1 mm (inclusive) and, more specifically, infrared light, a visible light beam, or ultraviolet light. The curable composition is a composition cured by light irradiation or heating. A photo-curable composition cured by light irradiation contains at least a polymerizable compound and a photopolymerization initiator, and may further contain a nonpolymerizable compound or a solvent, as needed. The nonpolymerizable compound is at least one material selected from the group consisting of a sensitizer, a hydrogen donor, an internal mold release agent, a surfactant, an antioxidant, and a polymer component. The viscosity (the viscosity at 25° C.) of the curable composition is, for example, 1 mPa·s (inclusive) to 100 mPa·s (inclusive).

As the material of the substrate, for example, glass, a ceramic, a metal, a semiconductor, a resin, or the like is used. A member made of a material different from the substrate may be provided on the surface of the substrate, as needed. The substrate includes, for example, a silicon wafer, a compound semiconductor wafer, or silica glass.

In the specification and the accompanying drawings, directions will be indicated on an XYZ coordinate system in which directions parallel to the surface of the substrate S are defined as the X-Y plane. Directions parallel to the X-axis, the Y-axis, and the Z-axis of the XYZ coordinate system are the X direction, the Y direction, and the Z direction, respectively. A rotation about the X-axis, a rotation about the Y-axis, and a rotation about the Z-axis are θX, θY, and θZ, respectively. Control or driving concerning the X-axis, the Y-axis, and the Z-axis means control or driving concerning a direction parallel to the X-axis, a direction parallel to the Y-axis, and a direction parallel to the Z-axis, respectively. In addition, control or driving concerning the θX-axis, the θY-axis, and the θZ-axis means control or driving concerning a rotation about an axis parallel to the X-axis, a rotation about an axis parallel to the Y-axis, and a rotation about an axis parallel to the Z-axis, respectively. In addition, a position is information that is specified based on coordinates on the X-, Y-, and Z-axes, and a posture is information that is specified by values on the θX-, θY-, and θZ-axes. Positioning means controlling the position and/or posture.

The film forming apparatus IMP includes a substrate holding unit SH that holds the substrate S, a substrate driving mechanism SD that moves the substrate S by driving the substrate holding unit SH, and a support base SB that supports the substrate driving mechanism SD. In addition, the film forming apparatus IMP includes a mold holding unit MH that holds the mold M, and a mold driving mechanism MD that moves the mold M by driving the mold holding unit MH.

The substrate driving mechanism SD and the mold driving mechanism MD form a relative movement mechanism that moves at least one of the substrate S and the mold M so as to adjust the relative position between the substrate S and the mold M. Adjustment of the relative position between the substrate S and the mold M by the relative movement mechanism includes driving to bring the curable composition IM on the substrate S into contact with the mold M and driving to separate the mold M from the cured curable composition IM on the substrate S. In addition, adjustment of the relative position between the substrate S and the mold M by the relative movement mechanism includes positioning between the substrate S and the mold M. The substrate driving mechanism SD is configured to drive the substrate S with respect to a plurality of axes (for example, three axes including the X-axis, Y-axis, and θZ-axis, and preferably six axes including the X-axis, Y-axis, Z-axis, θX-axis, θY-axis, and θZ-axis). The mold driving mechanism MD is configured to drive the mold M with respect to a plurality of axes (for example, three axes including the Z-axis, θX-axis, and θY-axis, and preferably six axes including the X-axis, Y-axis, Z-axis, θX-axis, θY-axis, and θZ-axis).

The film forming apparatus IMP includes a curing unit CU for curing the curable composition IM with which the space between the substrate S and the mold M is filled. For example, the curing unit CU cures the curable composition IM on the substrate S by applying the curing energy to the curable composition IM via the mold M.

The film forming apparatus IMP includes a transmissive member TR for forming a space SP on the rear side (the opposite side of a surface opposing the substrate S) of the mold M. The transmissive member TR is made of a material that transmits the curing energy from the curing unit CU, and can apply the curing energy to the curable composition IM on the substrate S.

The film forming apparatus IMP includes a pressure control unit PC that controls deformation of the mold M in the Z-axis direction by controlling the pressure of the space SP. For example, when the pressure control unit PC makes the pressure of the space SP higher than the atmospheric pressure, the mold M is deformed in a convex shape toward the substrate S.

The film forming apparatus IMP includes a dispenser DSP for arranging, supplying, or distributing the curable composition IM on the substrate S. However, the substrate S on which the curable composition IM is arranged by another apparatus may be supplied (loaded) to the film forming apparatus IMP. In this case, the film forming apparatus IMP need not include the dispenser DSP.

The film forming apparatus IMP may include an alignment scope AS for measuring a positional shift (alignment error) between the substrate S (or the shot region of the substrate S) and the mold M.

The information processing apparatus 1 that functions as a simulation apparatus executes computation of predicting the behavior of the curable composition IM in a process executed by the film forming apparatus IMP. More specifically, the information processing apparatus 1 executes computation of predicting the behavior of the curable composition IM in the process of bringing the plurality of droplets of the curable composition IM arranged on the substrate S into contact with the mold M and forming a film of the curable composition IM in the space between the substrate S and the mold M.

The information processing apparatus 1 is formed by, for example, incorporating a simulation program 21 in a general-purpose or dedicated computer. Note that the information processing apparatus 1 may be formed by a Programmable Logic Device (PLD) such as a Field Programmable Gate Array (FPGA). Alternatively, the information processing apparatus 1 may be formed by an Application Specific Integrated Circuit (ASIC).

In this embodiment, the information processing apparatus 1 can be formed by a computer including a processor 10, a memory 20, a display 30, and an input device 40. The simulation program 21 for predicting the behavior of the curable composition IM in the film forming process is stored in the memory 20. The processor 10 can perform simulation of predicting the behavior of the curable composition IM in the film forming process by reading out and executing the simulation program 21 stored in the memory 20. Note that the memory 20 may be a semiconductor memory, a disk such as a hard disk, or a memory of another form. The simulation program 21 may be stored in a computer-readable memory medium, or provided to the information processing apparatus 1 via a communication facility such as a telecommunication network.

The processor 10 can function as an obtaining unit that obtains the parameter set for the film forming process. The processor 10 can also function as a processor that obtains the behavior of the curable composition by simulation computation based on the parameter set. The processor 10 can further function as a display control unit that controls the display 30 so as to display a simulation image simulating the behavior of the curable composition obtained by the simulation computation.

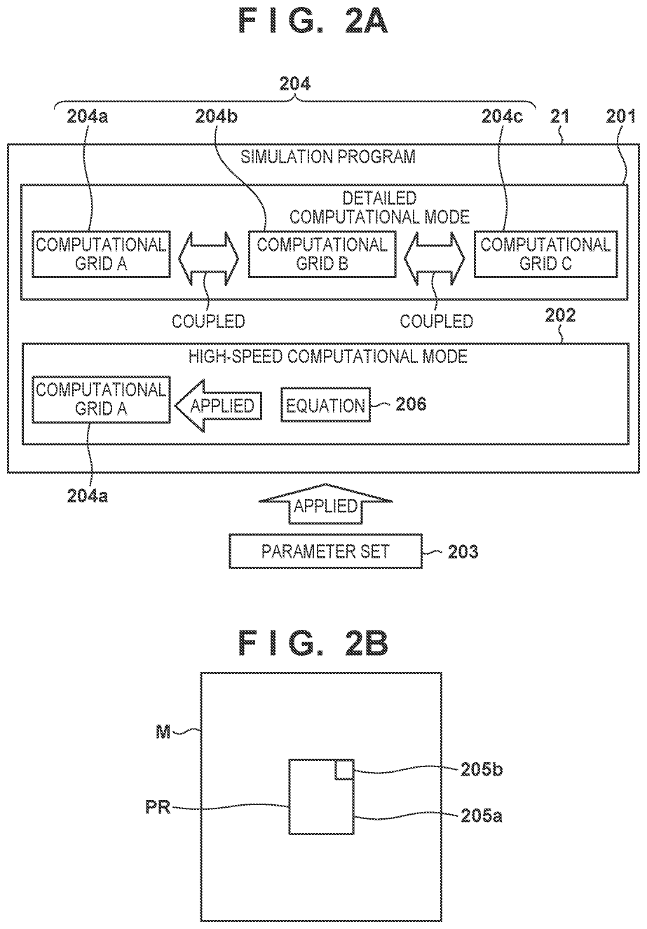

FIGS. 2A and 2B are views for explaining two computational modes of the simulation program 21 in this embodiment. The two computational modes include a mode in which computation is executed by the first computational method, and a mode in which computation is executed by the second computational method, and each of the two computational modes has its own characteristics. The first computational method is a method of computing the filling process with high accuracy, and executed as a detailed computational mode 201. The second computational method is a method of computing the filling process at a high speed, and executed as a high-speed computational mode 202. According to the second computational method, the computation time is shortened as compared to the first computational method. FIG. 2A is a schematic view showing the configuration of the simulation program 21 having the detailed computational mode 201 and the high-speed computational mode 202.

One of the purposes of mounting the simulation program 21 in the information processing apparatus 1 is to obtain the optimal parameter set for the film forming process at a low cost and in a short time. For example, in the process of filling the curable composition IM between the mold M and the substrate S to form a film, if the film is cured with a bubble remaining in the film, a defect occurs. Accordingly, the optimal parameter set is a parameter set for the film forming process in simulation that minimizes a remaining gas in the film. In this embodiment, since the description is based on the film forming apparatus IMP, the parameter set will be described as a parameter set that decides imprint conditions.

A parameter set 203 is a set of parameters for the film forming process, which are required for computation used in the simulation program 21. Examples of the parameters can be the model information of the mold M, the model information of the substrate S, the pressing force of the mold driving mechanism MD, the pressure to be generated in the space SP, and the arrangement and amount of the droplets of the curable composition IM. The above-described parameters are representative examples, and other parameters can also be used. Note that the parameter set 203 can be managed as one file. The file may be saved in the memory 20 of the information processing apparatus 1, or may be saved in an external server. Therefore, in this case, “a plurality of parameter sets” can be managed as a plurality of files. Each parameter included in the parameter set 203 may be manually input by an operator via an input screen.

As a method of deciding the parameter set 203, the parameter set 203 may be decided through trial and error by actually performing an imprint process. More specifically, a plurality of tentative parameter sets are prepared, and an imprint process is actually performed using the mold M and the substrate S while applying each tentative parameter set. Thereafter, the optimal parameter set is obtained by measuring a defect having occurred in the generated film of the curable composition IM. This method is highly reliable because the film is actually formed and the defect is inspected using an inspection machine. However, this method has problems in cost and time because it requires article arrangement for the imprint process, the inspection step by the inspection machine outside the information processing apparatus 1, and the like.

In the simulation using the simulation program 21, the processor 10 acquires information required for computation by referring to the tentative parameter set. For example, the processor 10 acquires information such as the dimensions and materials of the mold M and the substrate S from the model information of the mold M and the model information of the substrate S included in the tentative parameter set. The processor 10 also acquires information concerning the operation sequence of the mold driving mechanism MD from the information of the pressing force of the driving mechanism MD and the pressure generated in the space SP included in the tentative parameter set. Further, from information of the arrangement and amount of a plurality of droplets of the curable composition IM included in the tentative parameter set, the processor 10 acquires the positional information and amount of the droplets to be computed. The processor 10 computes and simulates the imprint process using the pieces of information acquired as described above. Since it is unnecessary to actually perform the imprint process, the final parameter set 203 can be decided at a low cost and in a short time.

Next, the two computational modes of the simulation program 21 will be described in detail. In each computational mode, the processor 10 creates a computational grid 204 to compute a physical phenomenon. The computational grid 204 is used to discretize the mathematical model representing the phenomenon to be computed. Depending on the physical phenomenon to be computed, the computational grid 204 capable of computing the physical phenomenon changes. Therefore, if a plurality of physical phenomena are to be computed, it is necessary to prepare a plurality of the computational grids 204. Accordingly, the kinds of computational grids to be prepared change depending on the computational mode. Even if the same computational grid 204 is used in the computational modes, the range to be computed may change.

In the detailed computational mode 201, the processor 10 executes physical computations for many physical phenomena assumed in filling simulation. In order to execute a plurality of physical computations, the processor 10 uses three computational grids 204. An example of the physical phenomenon computed by a computational grid A204a is the behavior of droplets of the curable composition IM. An example of the physical phenomenon computed by a computational grid B204b is the deformation (bending) of the mold M. An example of the physical phenomenon computed by a computational grid C204c is the pressure in the closed space SP on the back surface of the mold M. Note that the physical phenomena computed by the respective computational grids 204 are merely examples for description, and physical phenomena other than those introduced here are also computed in actual computations.

In the detailed computational mode 201, the plurality of physical phenomena are coupled and computed. For example, in the detailed computational mode 201, the behavior computation includes performing coupled computation for obtaining the relationship among the behavior of droplets of the curable composition IM, the deformation of the mold M, and the pressure in the closed space SP on the back surface of the mold M. More specifically, the coupled computation of the computational grid A204a and the computational grid B204b and the coupled computation of the computational grid B204b and the computational grid C204c are performed. With these coupled computations, the physical phenomena computed by the different computational grids 204 influence each other, and the prediction accuracy of the simulation improves. However, in the coupled computation, the computation time tends to be long since multiple linear computation operations are performed by iteration.

In the detailed computational mode 201, a region of evaluation 205 exemplarily shown in FIG. 2B is set to the entire region of the pattern region PR. The region of evaluation 205 here is the range for evaluating the result of the computation target of the simulation program 21 in the X direction and the Y direction in a plane. When discussing the range of the evaluation target of the simulation program 21, the magnitude of the range of the computation target will be discussed using the region of evaluation 205 limited in the X direction and the Y direction. Note that the creation range of the computational grid 204 changes in accordance with the range of the region of evaluation 205. For example, in the computational grid A204a, the computation range changes in accordance with the droplets of the curable composition IM to be computed.

With reference to FIG. 2B, the range of a region of evaluation 205a in the detailed computational mode 201 will be described. FIG. 2B is a view of the mold M viewed from the −Z direction. The region of evaluation 205 in the detailed computational mode 201 is defined as the region of evaluation 205a. Note that in FIG. 2B, the border of the pattern region PR and the border of the computational grid A204a are overlapped and displayed. The region of evaluation 205a is set to the range including all droplets of the curable composition IM. More specifically, in order to distribute the droplets of the curable composition IM over the range of the pattern region PR, the region of evaluation 205a is set to the entire region of the pattern region PR. In the computational grid A204a taken as an example, the computation range is set to all droplets of the curable composition IM. Thus, the computational grid A204a including all droplets is created. In this manner, by setting the computation target to all droplets, the influence of all droplets can be considered upon computing the deformed shape of the mold M. With this, it is possible to accurately obtain the deformation of the mold M, and the computation accuracy improves.

As has been described above, in the detailed computational mode 201, measures for improving the computation accuracy are taken. However, as a negative effect of improving the computation accuracy, the computation time increases.

Next, the high-speed computational mode 202 as the other computational mode will be described. In the high-speed computational mode 202, the computation contents are limited with the detailed computational mode 201 as the reference, thereby increasing the computation speed. More specifically, in the high-speed computational mode 202, computation is performed by giving attention to generation of bubbles generated in the film of the curable composition IM while considering the arrangement and amount of the curable composition IM. This computational method is effective in a fine adjustment step and the like. For example, the high-speed computational mode 202 is effective when used to, while giving attention to bubbles generated in the film of the curable composition IM at a specific position, finely adjust the arrangement and amount of the droplets of the curable composition IM, and check the increase/decrease of the gas generated in the film of the curable composition IM. By preparing a plurality of the parameter sets 203 including different arrangements and amounts of droplets of the curable composition IM, and performing computation using each of the plurality of the parameter sets 203 in the high-speed computational mode 202, it is possible to quantitatively compare the pieces of information of generated bubbles. In this embodiment, for the sake of descriptive convenience, the following description will be given while giving attention to a change of the arrangement of the droplets.

In the high-speed computational mode 202, the computation time is shortened by replacing the computational method employed in the detailed computational mode 201 with a simple computational method. When it is limited to check of bubble entrapment, the above-described computation concerning the behavior of droplets by the computational grid A204a is essential. Therefore, the computation by the computational grid A204a is essential. However, of the computational grid B204b and the computational grid C204c, the physical phenomenon strongly related to generation of bubbles is the bending computation for computing the deformed shape of the mold M. The bending computation of the mold M is performed using the computational grid B204b. However, for the computation with high accuracy, it is desirable to perform coupled computation with the computational grid A204a and the computational grid C204c. As compared to other computations, this requires a lot of computation time. To cope with this, in the high-speed computational mode 202, instead of the coupled computation, the bending distribution of the mold M is computed using an equation 206. This can shorten the computation time (reduce the operation amount). For example, since the mold M is deformed into a convex shape toward the substrate S, the central portion of the mold M first comes into contact with the curable composition IM. The contact area is determined from positional information of the driving mechanism MD with respect to the substrate S. The contact portion is regarded as a fixed portion which is not deformed, and the non-contact portion is regarded as the computation target, which is deformed. In addition, assume that the pressure applied to the space SP is uniformly distributed to the computation target portion of the mold M. With the assumption as described above, a disk bending formula can be applied, and the bending distribution of the mold M can be expressed by the equation 206. By applying the parameter of the mold M to the equation 206 serving as a predetermined model formula, the deformation of the mold M can be easily computed.

Note that in this embodiment, the example of replacement with the equation 206 has been described, but the bending (deformation) of the mold may be predicted using a past computation result of the bending of the mold M, a past measurement result of the bending of the mold M obtained by measurement, or the like, which is obtained in advance. More specifically, the computation result or measurement result is registered in the memory 20 as a database and referred to. With this, the computation is simplified, and the computation time can be shortened.

In an example, in the high-speed computational mode 202, the computation time can be shortened by performing computation while reducing the physical computations as computation targets. As has been described above, by applying the disk bending formula and computing the bending distribution of the mold M using the equation 206, the computational grid B204b and the computational grid C204c are omitted. This means that the computation of the pressure in the closed space SP on the back surface of the mold M, which is computed by the computational grid C204c, is omitted, so that the computation time is shortened by the time required for the omitted computation. In this manner, in the high-speed computational mode 202, the computation time can be shortened by decreasing the physical amount of the computation targets.

In another example, in the high-speed computational mode 202, the computation time can be shortened by limiting the region of evaluation 205 to a local range. That is, the computation time can be shortened by limiting the region of evaluation of the behavior computation by the second computational method to a part of the region of evaluation of the behavior computation by the first computational method. The region of evaluation 205 in the high-speed computational mode 202 is defined as a region of evaluation 205b as exemplarily shown in FIG. 2B. In the detailed computational mode 201, the region of evaluation 205a is set to the entire region of the pattern region PR to increase the computation information amount, but in the high-speed computational mode 202, the evaluation target is limited to shorten the computation time. More specifically, in the detailed computational mode 201, the evaluation target is set to all droplets of the curable composition IM. However, in the high-speed computational mode 202, as shown in FIG. 2B, the region of evaluation 205b is designated in which the evaluation target is set to only the droplets near the area of interest. For example, a portion where a bubble is likely to be generated, such as a corner portion of the arrangement of the droplets, the shape of the mold M, the shape of the substrate S, or the pattern region PR, can be designated as the region of evaluation 205b. Alternatively, a location where generation of a problem bubble has been found in measurement by a defect inspection apparatus or another analysis can be designated as the region of evaluation 205b. In the computational grid A204a taken as an example in the description of the detailed computational mode 201, since the range to evaluate the droplets is set to the droplets of the curable composition IM within this range, the computational grid A204a decreases. Since the computational grid A204a decreases, the computation time also decreases accordingly.

As has been described above, in the high-speed computational mode 202, the physical computations as computation targets are reduced, the computation by the computational grid 204 is replaced with a simple computational method, and the region of evaluation 205 is limited to a local range, thereby significantly increasing the computation speed as compared to that in the detailed computational mode 201. With this, it is possible to compare the amount of bubble defects between the drop recipes in a short time.

Note that in this embodiment, as has been described above, since attention is given to decision of the arrangement of the droplets of the curable composition IM, the time shortening method as described above is used. The high-speed computational mode 202 is used while changing the time shortening method in accordance with the parameter set 203.

Note that the names “detailed” and “high-speed” here are given by relatively comparing the two computational modes described in this embodiment. For example, the detailed computational mode 201 may be regarded as the standard computational mode to be originally executed by the simulation program 21. In this case, the mode, in which a limit is made on the standard computational mode to improve the computation speed so that the computation speed improves but the computation accuracy decreases, may be understood as the high-speed computational mode.

The plurality of the parameter sets 203 including different parameters are prepared, and the simulation program 21 executes computation using each of the plurality of the parameter sets 203.

If there is only one computational mode, the total computation time increases in proportion to the number of computations. To the contrary, when all computations are executed in the computational mode such as the high-speed computational mode 202 in which the computation is completed in a short time, it is possible to narrow down the parameter sets to the parameter set including the imprint condition that should be computed in the computational mode such as the detailed computational mode which takes time. For example, if the computation time by the detailed computational mode is about two hours and the computation time by the high-speed computational mode is about one minute, the shortened time is obvious. Hence, by preparing two computational modes and properly using them as in this embodiment, the total computation time can be shortened.

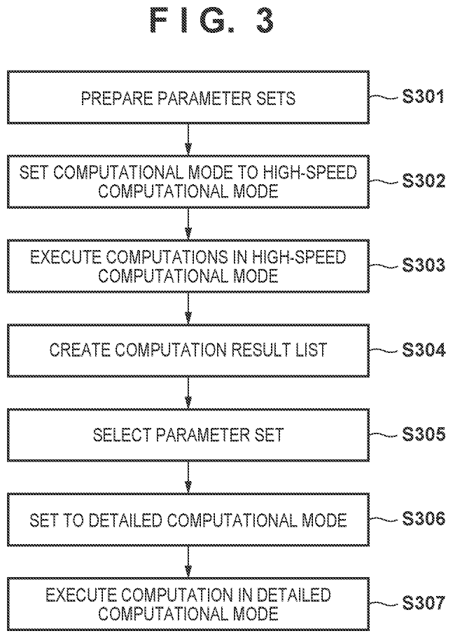

FIG. 3 is a flowchart for explaining the computational procedure of simulation in this embodiment. In this flowchart, a plurality of parameter sets are respectively applied to the high-speed computational mode 202 and high-speed computations are performed. Based on the results, the parameter set to be applied to the detailed computational mode 201 is decided. Note that the contents of the parameter set 203 follow the contents described above with reference to FIG. 2.

Note that the flowchart of FIG. 3 is compatible with automatic execution by program processing. If a file such as a sequence file that can describe a series of setting information and operation procedures can be prepared, the operation efficiency is improved by performing automatic execution using the sequence file. In this embodiment, a case in which automatic execution is performed will be described.

In step S301, the processor 10 prepares a plurality of tentative parameter sets. For example, the processor 10 prepares a plurality of tentative parameter sets including different droplet arrangements. In this preparation, the region of evaluation 205 is designated. The region of evaluation 205 decides the computation target of the high-speed computational mode 202. Note that multiple regions of evaluation 205 may be designated. If multiple regions of evaluation 205 are designated, the number of computations in the high-speed computational mode 202 increases in accordance with the number of the multiple regions of evaluation 205, but the parameter set 203 can be selected more strictly. In this embodiment, in order to simplify the later description, the description will be continued while assuming that one region of evaluation 205 is designated. This embodiment assumes that ten tentative parameter sets are prepared. The ten tentative parameter sets are different from each other in the X and Y coordinates of the droplet arrangement.

The tentative parameter sets may be those registered in the memory 20 via operator's input operation. Alternatively, the tentative parameter sets may be creased by a program that automatically generates parameter sets by inputting the condition of the droplet arrangement to be changed.

In step S302, the processor 10 sets the computational mode to the high-speed computational mode 202. In this embodiment, the simulation program 21 has the detailed computational mode 201 and the high-speed computational mode 202. Hence, the processor 10 sets the computational mode to be used to the high-speed computational mode 202. More specifically, a switching command is described in the sequence file, and the processor 10 receives the command and automatically switches the computational mode to the high-speed computational mode 202.

In step S303, the processor 10 executes computation in the high-speed computational mode 202. In this step, the processor 10 executes computation in the high-speed computational mode 202 while applying each of the plurality of tentative parameter sets prepared in step S301. Since ten tentative parameter sets are prepared in this embodiment, ten computations in total are executed. The computation is executed automatically, and ten computations are successively executed.

In step S304, the processor 10 creates a computation result list. The processor 10 saves, in the memory 20, the computation results for the plurality of tentative parameter sets in one file as the computation result list. The kinds of computation results to be saved need to include at least the item of evaluation for the threshold determination which will be introduced in the next step. Since 10 tentative parameter sets are prepared in this embodiment, ten sets of computation results are described in the computation list. Further, in this embodiment, the description will be given assuming that the computation result includes the number of bubble defects and the size of the maximum defect. Note that the computation list is automatically created.

In step S305, the processor 10 selects the parameter set. The processor 10 decides, from the plurality of tentative parameter sets, the parameter set that produces a result of the behavior computation in the high-speed computational mode 202 satisfying a predetermined criterion for evaluation. A plurality of determination programs (modules) having different algorithms may be provided, and the parameter set may be decided by one determination program selected from the plurality of determination programs. The plurality of determination programs may be installed in the memory 20, and one of them may be used.

Since the computation results have been already saved together as the computation result list in step S304, the parameter set is decided (selected) while referring to the computation result list in step S305. In the results of the behavior computations respectively corresponding to the plurality of tentative parameter sets, information concerning the size of the maximum bubble defect and the number of bubble defects is referred to.

First, it is necessary to make a policy for the determination program to determine the computation result. The above-described predetermined criterion for evaluation can be that the size of the maximum bubble defect is equal to or smaller than an allowable value and the number of bubble defects is equal to or smaller than an allowable number. For example, a policy is made which defines that the first priority for determination is the condition that the size of the maximum bubble defect is equal to or smaller than the allowable value, the second priority for determination is the condition that the number of bubble defects is equal to or smaller the allowable number, and one or more parameter sets from the best concerning these conditions are selected. For example, if ten tentative parameter sets are registered in the computation result list, the processor 10 refers to each of the computation results to find the parameter set satisfying the above-described conditions, and selects a predetermined number (for example, one) of parameter sets from the ten parameter sets. Note that the determination is automatically performed according to the determination program. Note that the determination policy is not limited to the contents described here, and can be arbitrarily set by the operator. Narrowing down of the parameter set candidates here directly leads to shortening of the computation time. This is because the computations corresponding to the number of the parameter sets selected as candidates here will be performed later in the detailed computational mode 201. Accordingly, from the viewpoint of time, the number of parameter sets to be selected is desirably as small as possible, but from the viewpoint of evaluation of the computation results, the number is desirably as large as possible. Hence, the number should be chosen carefully.

There can be a case in which no parameter set matches the policy (the predetermined criterion for evaluation). In this case, the parameter set close to the policy may be selected, or the process may exit from the flowchart here and computation in the detailed computational mode 201 to be described later may not be performed.

In step S306, the processor 10 sets the computational mode to the detailed computational mode 201. Since the simulation program 21 has been set to the high-speed computational mode 202 in step S302, the computational mode is switched and set to the detailed computational mode 201 in step S306. More specifically, the switching command is described in the sequence file, and the processor 10 receives the command and automatically switches the computational mode to the detailed computational mode 201.

In step S307, the processor 10 executes computation in the detailed computational mode 201. Here, the processor 10 executes computation in the detailed computational mode 201 while applying the parameter set selected in step S305. If the parameter sets have been narrowed down to one parameter set in step S305, one computation result can be obtained in the detailed computational mode 201.

Since the computation result obtained here is more detailed information than the computation result obtained in the high-speed computational mode 202, it can be used for final check of generation information of bubbles. In addition, since bubble disappearance computation is performed, it is also possible to evaluate the results of more physical computations such as the evaluation of the filling completion time. If there is no problem, the narrowed-down parameter set may be set intact as the final parameter set, or the flowchart may be executed again to decide another parameter set. By repetitively performing the evaluation, the final parameter set to be used by the film forming apparatus IMP is decided. This is the representative method of use.

By executing the steps described so far, the detailed computational mode 201 is not applied to all of the plurality of tentative parameter sets, and the parameter set candidates are narrowed down using the high-speed computational mode 202. Thus, the number of computations by the detailed computational mode 201 can be reduced. With this, the total computation time for deciding the parameter set can be shortened.

As has been described above, according to this embodiment, the simulation program has the computational mode for performing detailed computation and the computational mode for performing computation at a high speed, and the time required for simulation can be shortened by performing computations while taking advantages of the characteristics of the respective computational modes. For example, by executing computations in the high-speed computational mode using the plurality of tentative parameter sets to narrow down the parameter sets, and executing computation in the detailed computational mode using the narrowed-down parameter set alone, the total computation time required for computations can be suppressed.

As has been described above, by shortening the total computation time of simulation, it is possible to provide a method for shortening the time required to decide the parameter set.

### Second Embodiment

In the second embodiment, the computational mode is switched using a user interface configured to present options for accepting a user instruction concerning the parameter set for a film forming process and a computational method, and accept a user instruction to start execution of behavior computation. In this embodiment, this user interface is implemented using a display 30 provided in an information processing apparatus 1. The display 30 provides a Graphical User Interface (GUI). In this embodiment, an operator (user) visually checks the computation result via the GUI, and the operator manually switches the computational mode. Note that the second embodiment overlaps the first embodiment in many points. Therefore, only differences of the second embodiment from the first embodiment will be described.

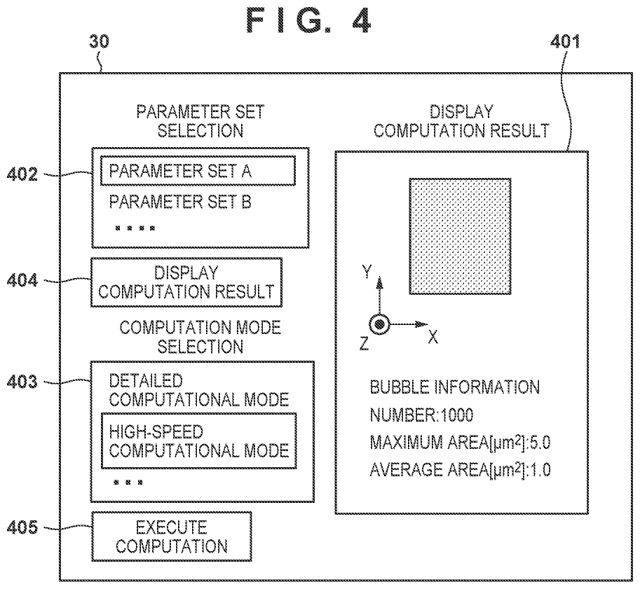

FIG. 4 is a view showing an example of the GUI provided on the display of the information processing apparatus 1 in the second embodiment. The GUI provided on the display 30 can include a display window 401. The display window 401 is a general display window for displaying various visual information. The GUI can also include a parameter set selection window 402. A plurality of parameter sets registered in a memory 20 are displayed in the parameter set selection window 402. The user can select, using an input device one or more parameter sets from the plurality of displayed parameter sets. Note that multiple parameter sets can be selected.

The GUI can further include a computational mode selection window 403. The computational modes of a simulation program 21 are displayed in the computational mode selection window 403. The above-described manual switching of the computational mode can be performed via the selection window 403. Since a detailed computational mode 201 and a high-speed computational mode 202 are used in this embodiment, the two computational modes are displayed. The computational mode can be selected using the input device 40. The computational mode selected here is used to execute computation.

The GUI can further include a computation result display button 404. If the computation result display button 404 is pressed while the parameter set is selected in the parameter set selection window 402, the computation result is displayed in the display window 401.

The GUI can further include a computation execution button 405. In response to pressing of the computation execution button 405 while the parameter set is selected in the parameter set selection window 402 and the computational mode is selected in the computational mode selection window 403, behavior computation is executed.

The second embodiment is similar to the first embodiment up to preparation of a plurality of tentative parameter sets and execution of computation in the high-speed computational mode 202 using the plurality of tentative parameter sets. In the second embodiment, the computation result in the detailed computational mode 201 can be acquired using the GUI. If the computation execution button 405 is pressed while a parameter set 203 to be used in computation is selected in the parameter set selection window 402 and the high-speed computational mode 202 is selected in the computational mode selection window 403, the computation result in the high-speed computational mode 202 is obtained.

In the state in which the computation result in the high-speed computational mode 202 has been obtained, if the parameter set is selected in the parameter set selection window 402 and the computation result display button 404 is pressed, the computation result is displayed in the display window 401. There can be a large number of computation result display methods, but in FIG. 4, a color contour showing the sizes of distributed bubble defects, the number of bubble defects, the maximum area of the bubble in the X-Y plane, and the average area of the bubbles in the X-Y plane can be displayed. The display information can be changed by setting. Note that the size of the bubble is displayed here not in volume but in the X-Y plane in order to match the value with the measurement value of the bubble generated in the film of a curable composition IM in an external apparatus, which is measured in the X-Y plane.

In FIG. 4, information of the computation result for one parameter set is displayed. However, it is also possible to compare and evaluate multiple computation results by selecting multiple parameter sets in the parameter set selection window 402.

The operator checks the information of the computation result, and selects the parameter set to be used in computation in the detailed computational mode 201. Note that a new parameter set may be created based on findings obtained by referring to the computation result, and the new parameter set may be set as a computation candidate in the detailed computational mode 201.

After referring to the computation result, the operator selects, from the parameter set selection window 402, the parameter set 203 to be used to execute the detailed computational mode. Then, the operator selects the detailed computational mode 201 in the computational mode selection window 403. After that, by pressing the computation execution button 405, computation in the detailed computational mode 201 is executed.

As has been descried above, in this embodiment, a method has been described in which the parameter set to be used in the detailed computational mode 201 is decided and manually selected by the operator. In the first embodiment, since automatic execution is performed, the effect of increasing the total computation speed is high. To the contrary, in this embodiment, since the computation result is checked by the operator before computation in the detailed computation mode 201, rework is reduced even if there is a mistake in the automation sequence, and flexible decision after checking the result is possible. It is desirable to use them properly in accordance with the intended use.

Also in this embodiment, by executing computations in the high-speed computational mode using a plurality of tentative parameter sets to narrow down the parameter sets, and executing computation in the detailed computational mode using the narrowed-down parameter set alone, the total computation time required for computations can be suppressed.

As has been described above, by shortening the total computation time of simulation, it is possible to provide a method for shortening the time required to decide the parameter set.

### Third Embodiment

In the third embodiment, a region of evaluation 205 is selected based on information obtained from the computation result in a detailed computational mode 201, and then computation in a high-speed computational mode 202 is executed. More specifically, in the third embodiment, a problem range is specified in advance based on the computation result in the detailed computational mode 201, and the region of evaluation 205 is selected based on the information of the specified range. Thereafter, a plurality of parameter sets aiming at improvement are prepared, and computations in the high-speed computational mode 202 are executed. Examples of the problem range are a portion where a large bubble is generated, a portion where bubbles are intensively generated, and the like.

Note that the third embodiment overlaps the first embodiment in many points. Therefore, only differences of the third embodiment from the first embodiment will be described.

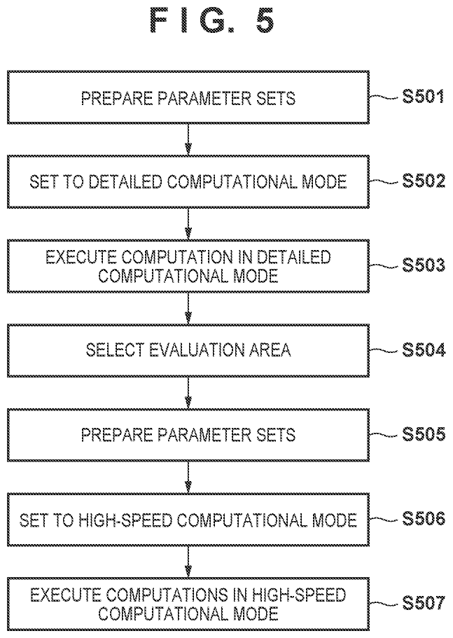

FIG. 5 is a flowchart for explaining the computational procedure of simulation in the third embodiment.

In step S501, a processor 10 prepares a parameter set. In this embodiment, it is assumed that the portion where a bubble defect occurs is known. Therefore, in step S501, the parameter set is prepared, which has caused the problem of bubble defect in a film forming apparatus IMP.

In step S502, the processor 10 sets the computational mode to the detailed computational mode 201. In step S503, the processor 10 executes computation in the detailed computational mode 201. In this step, one computation in the detailed computational mode 201 is executed in accordance with the parameter set prepared in step S501. Since the bubble generation portion is already known in this embodiment, it can be checked in this stage whether the computation is not different from the actual phenomenon. If there is a difference, the flowchart is interrupted, and the parameter set to be prepared in step S501 may be reviewed.

In step S504, the processor 10 selects the region of evaluation 205. As has been described above, the portion where a large bubble is generated or the portion where bubbles are intensively generated is regarded as the candidate for the region of evaluation 205. As has been described in the first embodiment, the region of evaluation 205 is not necessarily limited to one region, and multiple regions of evaluation 205 may be selected. However, it should be noted that the computation time increases as the number of the regions of evaluation 205 increases.

In step S505, the processor 10 prepares a plurality of tentative parameter sets. For example, the plurality of tentative parameter sets obtained by changing the X coordinate or Y coordinate of the droplet of a curable composition IM, which is likely to cause bubble generation in the range of the region of evaluation 205, are prepared. Note that, since it is necessary to examine a plurality of tentative parameter sets, the plurality of parameter sets are generally prepared in step S505.

In step S506, the processor 10 sets the computational mode to the high-speed computational mode 202. In step S507, the processor 10 executes computations in the high-speed computational mode 202. Here, the processor 10 executes computations in the high-speed computational mode 202 while applying the plurality of parameter sets prepared in step S505.

By referring to the obtained computation results, it is possible to predict an increase/decrease of bubbles upon changing the arrangement of the droplets of the curable composition IM. The best parameter set may be used to execute computation in the detailed computational mode 201, thereby obtaining the detailed simulation result of bubbles. Alternatively, the best parameter set may be used to actually perform an imprint process in the film forming apparatus IMP, thereby confirming the effect of reducing bubble defects.

As has been described above, also in this embodiment, by using computation in the high-speed computational mode 202, the number of computations by the detailed computational mode 201 can be suppressed. Thus, the total computation time required for simulation can be suppressed.

As has been described above, by shortening the total computation time of simulation, it is possible to provide a method for shortening the time required to decide the parameter set.

### Fourth Embodiment

In the application examples described above, a case has been described in which the film forming apparatus IMP is an imprint apparatus. However, the present invention is also effective in another apparatus that performs a filling process similar to that of the imprint apparatus. For example, a planarization apparatus described above is an example of the other apparatus.

To give a specific application example, the present invention can be applied to planarization of unevenness of about 0.5 to 1 which has been generated in a substrate during a device process, so as to match the depth of focus of a lithography technique. One of the planarization methods is a method in which resin droplets are applied between a flat mold and a substrate by an inkjet technique, and the mold and the substrate are pressed against each other to form a flat composition film on the substrate, thereby achieving planarization. In such the planarization apparatus, it is necessary to decide a parameter set for the planarization process, and the contents of the decision processing are similar to those in the imprint apparatus. Therefore, the present invention can be applied to the above-described process.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-099046, filed Jun. 20, 2022, which is hereby incorporated by reference herein in its entirety.

What is claimed is:

1. A simulation apparatus that predicts a behavior of a curable composition in a film forming process in which a plurality of droplets of the curable composition arranged on a substrate and a mold are brought into contact with each other to form a film of the curable composition on the substrate, the apparatus comprising:
a processor configured to execute behavior computation of the curable composition by a computational method selected from a first computational method and a second computational method which shortens a computation time as compared to the first computational method,
wherein the processor is configured to
execute behavior computation of the curable composition by the second computational method while applying each of a plurality of tentative parameter sets for the film forming process,
decide, from the plurality of tentative parameter sets, a parameter set that produces a result of the behavior computation satisfying a predetermined criterion for evaluation, and
execute behavior computation of the curable composition by the first computational method while applying the decided parameter set.

2. The apparatus according to claim 1, wherein
the behavior computation by the first computational method includes performing coupled computation for obtaining a relationship among a behavior of droplets of the curable composition, a deformation of the mold, and a pressure in a space on a back surface of the mold, and
the behavior computation by the second computational method includes, instead of the coupled computation, computing a deformation of the mold by applying a parameter of the mold to a predetermined model formula.

3. The apparatus according to claim 1, wherein
the behavior computation by the first computational method includes performing coupled computation for obtaining a relationship among a behavior of droplets of the curable composition, a deformation of the mold, and a pressure in a space on a back surface of the mold, and
the behavior computation by the second computational method includes, without performing the coupled computation, predicting a deformation of the mold using one of a past computation result of a deformation of the mold and a past measurement result of a deformation of the mold.

4. The apparatus according to claim 1, wherein
a region of evaluation of the behavior computation by the second computational method is limited to a part of a region of evaluation of the behavior computation by the first computational method.

5. The apparatus according to claim 1, wherein
a result of the behavior computation includes information of a size of a maximum bubble defect and the number of bubble defects, and
the predetermined criterion for evaluation is that the size of the maximum bubble defect is not more than an allowable value and the number of bubble defects is not more than an allowable number.

6. A simulation apparatus that predicts a behavior of a curable composition in a film forming process in which a plurality of droplets of the curable composition arranged on a substrate and a mold are brought into contact with each other to form a film of the curable composition on the substrate, the apparatus comprising:
a processor configured to execute behavior computation of the curable composition by a computational method selected from a first computational method and a second computational method which shortens a computation time as compared to the first computational method; and
a user interface configured to present options for accepting a user instruction concerning a parameter set for the film forming process and a computational method, and accept a user instruction to start execution of behavior computation,
wherein, in response to an input of the user instruction to start execution via the user interface, the processor executes behavior computation of the curable composition by a computational method selected from computational method options including the first computational method and the second computational method while applying a parameter set selected from parameter set options.

7. The apparatus according to claim 6, wherein
the user interface is configured so as to allow a user to select multiple parameter sets from the parameter set options, and
if the user selects multiple parameter sets from the parameter set options, and the user selects the second computational method from the computational method options, the processor executes behavior computation of the curable composition by the second computational method while applying each of the multiple selected parameter sets.

8. The apparatus according to claim 7, wherein
the user interface includes a display window configured to display a result of executed behavior computation, and
after behavior computation of the curable composition is executed by the second computational method while applying each of the multiple selected parameter sets, in response to the user selecting one parameter set among the multiple parameter sets from the options, the display window displays a result of behavior computation executed while applying the selected parameter set.

9. The apparatus according to claim 8, wherein
after behavior computation of the curable composition is executed by the second computational method while applying each of the multiple selected parameter sets, if the user instruction to start execution is input in a state in which one parameter set among the multiple parameter sets is selected from the options by the user and the first computational method is selected, the processor executes behavior computation of the curable composition by the first computational method while applying the selected parameter set.

10. A simulation apparatus that predicts a behavior of a curable composition in a film forming process in which a plurality of droplets of the curable composition arranged on a substrate and a mold are brought into contact with each other to form a film of the curable composition on the substrate, the apparatus comprising:
a processor configured to execute behavior computation of the curable composition by a computational method selected from a first computational method and a second computational method which shortens a computation time as compared to the first computational method,
wherein the processor is configured to
execute behavior computation of the curable composition by the first computational method while applying a tentative parameter set for the film forming process,
decide a region of evaluation based on a result of the behavior computation applied with the tentative parameter set, and
execute behavior computation of the curable composition by the second computational method while applying each of a plurality of tentative parameter sets with respect to the decided region of evaluation.

11. A simulation apparatus that predicts a behavior of a curable composition in a film forming process in which a plurality of droplets of the curable composition arranged on a substrate and a mold are brought into contact with each other to form a film of the curable composition on the substrate, the apparatus comprising:
a processor configured to execute behavior computation of the curable composition by a computational method selected from a first computational method and a second computational method which shortens a computation time as compared to the first computational method.

12. A computer-readable storage medium storing a program for causing a computer to function as a processor in a simulation apparatus defined in claim 1.
